(19) United States
(12) Patent Application Publication
(10) Pub. No.: US 2011/0290055 A1
(43) Pub. Date: Dec. 1, 2011

(54) SYSTEMS AND METHODS FOR ENGAGEMENT AND DISENGAGEMENT OF GEARS

(76) Inventors: Jerry Hielkema, Rockton, IL (US); Craig Legault, Rockford, IL (US)

(21) Appl. No.: 12/788,082

(22) Filed: May 26, 2010

(51) Int. Cl. F16H 61/28

(52) U.S. Cl. 74/473.12

(57) ABSTRACT

Systems and methods for engagement and disengagement of gears are provided. In one embodiment, the invention relates to a gear engagement system including a first crown gear assembly including a first crown gear including first crown teeth including a non-magnetic material and a ring including a first magnetic material and coupled along a circumference of the first crown gear, a second crown gear including second crown teeth including a second magnetic material and configured to engage with the first crown teeth, and switching circuitry for selectively engaging and disengaging the first crown teeth and the second crown teeth.

### BACKGROUND

The present invention relates to an apparatus for the mechanical engagement and disengagement of gears. More specifically, the present invention relates to an apparatus in which gears are selectively engaged and disengaged using a magnetic field.

In conventional apparatuses for engaging and disengaging gears, the tips of a first gear magnetically latch with the tips of a second gear in a tip-to-tip engagement. In such case, the first and second gears are held together primarily by a magnetic field. Therefore, if an amount of torque applied to the gears exceeds the limit of the torque that can be withstood by the magnetic coupling, then the engagement between the first and second gears is broken, which may result in undesirable slippage. In an effort to prevent this, conventional engagement systems are often designed to apply a limited amount of torque to avoid breaking the tip-to-tip gear engagement. In contrast, in a tip-to-root engagement (or “positive lock”), there is an additional mechanical advantage such that more torque can be transmitted between the first and second gears. Therefore, it would be desirable to have an apparatus for engaging and disengaging gears which provides for positive lock engagement.

### SUMMARY

Embodiments of the present invention are directed to systems and methods for engagement and disengagement of gears. In one embodiment, the invention relates to a gear engagement system including a first crown gear assembly including a first crown gear including first crown teeth including a non-magnetic material and a ring including a first magnetic material and coupled along a circumference of the first crown gear, a second crown gear including second crown teeth including a second magnetic material and configured to engage with the first crown teeth, and switching circuitry for selectively engaging and disengaging the first crown teeth and the second crown teeth.

In another embodiment, the invention relates to a method of operating a gear engagement system including inducing a magnetic field in a ring including a magnetic material and located along a circumference of a first crown gear including a plurality of first crown teeth including a non-magnetic material, where the first crown teeth are configured to engage with a plurality of second crown teeth including a magnetic material, the second crown teeth being configured to engage with the first crown teeth, where tips of the first crown teeth are configured to engage with roots of the second crown teeth and tips of the second crown teeth are configured to engage with roots of the first crown teeth, and where the second crown teeth are configured to move toward the first crown teeth when the magnetic field is induced in the ring.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view of a gear engagement system according to one embodiment of the present invention.

FIG. 2 is a perspective view of a gear engagement system according to one embodiment of the present invention.

FIG. 3 is a perspective view of an inner portion of a first crown gear, a second crown gear, and a ring of a gear engagement system according to one embodiment of the present invention.

FIG. 4 is a perspective view of an inner portion of a first crown gear and a ring of a gear engagement system according to one embodiment of the present invention.

FIG. 5 is an enlarged side view of a portion of a first crown gear and a ring according to one embodiment of the present invention.

FIG. 6 is a side view of an outer portion of a gear engagement system where the tips of the first crown teeth and the tips of the second crown teeth are in contact with one another according to one embodiment of the present invention.

FIG. 7 is a side view of the outer portion of a gear engagement system where the first crown teeth and the second crown teeth are mated in a positive lock engagement according to one embodiment of the present invention.

### DETAILED DESCRIPTION

A conventional gear engagement system which may be used in a clutch or brake may include first and second crown gears which can be selectively engaged and disengaged through the use of an electromagnet. When the electromagnet is energized, the first and second crown gears, which are generally made of magnetic materials, are attracted to one another and engage one another, thereby allowing torque to be transmitted from one gear to another. When the electromagnet is de-energized, a spring coupled to the first and second crown gears separates the two crown gears, thereby disengaging them from one another.

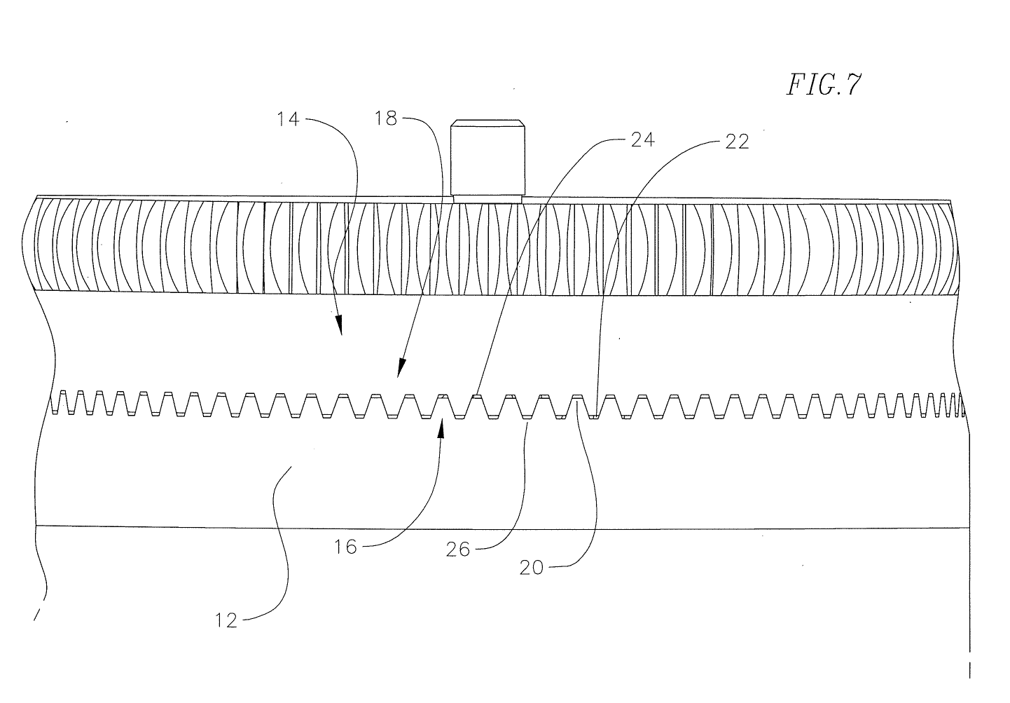

However, when the first and second crown gears are both made of magnetic materials, the tips of the gears (e.g., the tips of the first crown teeth 20 and the tips of the second crown teeth 22 in FIG. 6) generally magnetically latch with one another in a “tip-to-tip engagement” (see, for example, FIG. 6). In this undesirable configuration, the amount of torque that can be transmitted between the crown gears is limited based on the strength of the magnetic field and the friction between the first and second tips. If a relatively small amount of torque is applied to crown gears engaged in a tip-to-tip fashion, the first and second crown gears may slip or disengage. Therefore, some conventional systems limit the amount of torque that is applied to the gears to avoid breaking the tip-to-tip engagement. In contrast, when the tips of the first crown gear engage with the roots of the second crown gear (and vice versa) to establish a “positive lock,” then a larger amount of torque can be transmitted between the crown gears because the torque is supplied to and supported by the sides of the first and second crown teeth. Aspects of the present invention are directed to gear engagement systems that substantially avoid a tip-to-tip engagement and establish a positive lock engagement.

Referring now to the drawings, embodiments of gear engagement systems include a first crown gear and a ring. The first crown gear includes first crown teeth which are made of a non-magnetic material and the ring is made of a magnetic material. The ring is coupled along a circumference (e.g., inner or outer circumference) of the first crown gear. The gear engagement system further includes a second crown gear having second crown teeth which are made of a magnetic material. The second crown gear is designed to engage with the first crown gear (i.e., the first crown teeth mesh with the second crown teeth). The gear engagement system includes switching circuitry which is used to control the engagement and disengagement of the first and second crown teeth. Because the first crown teeth are made of a non-magnetic material, tips of the second crown teeth are unable to magnetically latch with tips of the first crown teeth, thereby substantially preventing tip-to-tip engagement. In addition, the magnetic ring selectively draws the tips of the second crown teeth toward the roots of the first crown teeth in order to achieve a positive lock engagement.

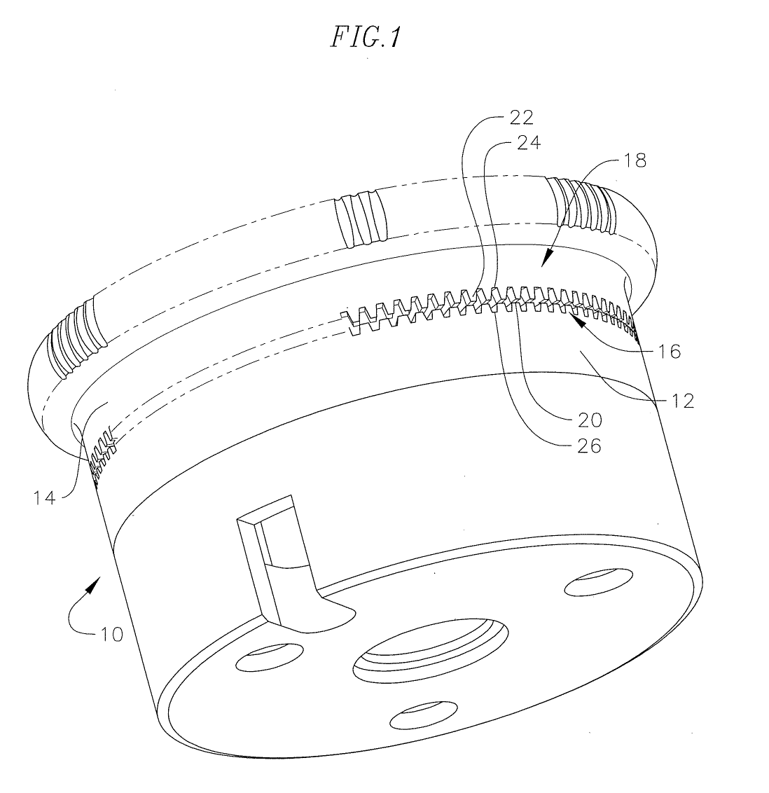

FIG. 1 is a perspective view of a gear engagement system according to one embodiment of the present invention. The gear engagement system includes a first crown gear assembly 10 which includes a first crown gear 12 that can engage with a second crown gear 14. The first crown gear 12 and second crown gear 14 include a plurality of first crown teeth 16 and a plurality of second crown teeth 18, respectively.

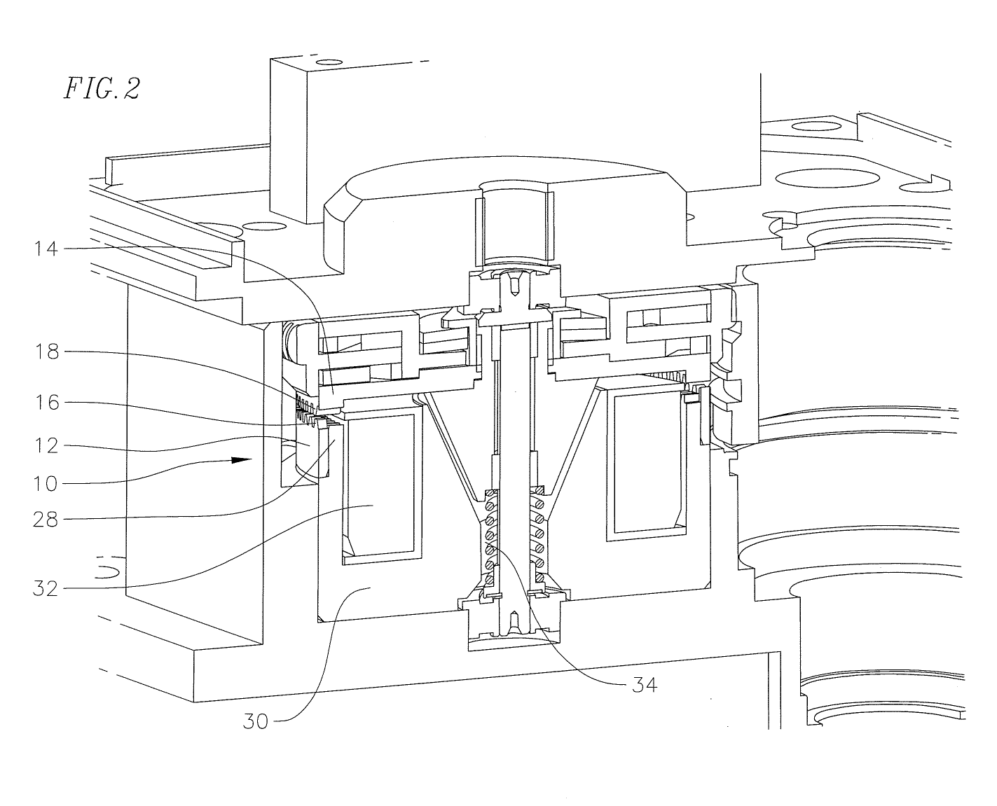

The first crown teeth 16 can be made of a non-magnetic material. A ring 28 (see FIG. 2) attached to the first crown teeth 16 is made of magnetic material that can be selectively engaged as part of an electromagnet. In such case, the second crown teeth 18 and ring 28 are magnetically attracted to achieve a positive lock between the first and second crown teeth.

As discussed above, tip-to-tip engagement is mechanically weaker than a “positive lock” engagement where the tips of the first crown teeth 20 are substantially positioned at (or are mated with) the roots of the second crown teeth 24, and, correspondingly, the tips of the second crown teeth 22 substantially engage the roots of the first crown teeth 26 (see, e.g., FIG. 7).

FIG. 2 is a perspective view of a first crown gear, a second crown gear, and a ring of a gear engagement system according to one embodiment of the present invention. The gear engagement system includes the first crown gear assembly 10 which includes the first crown gear 12 and the ring 28. The gear engagement system also includes the second crown gear 14, an electromagnetic coil 32, a housing 30, and a spring 34. The first crown gear 12 and the second crown gear 14 are configured such that the first crown teeth 16 and the second crown teeth 18 can be selectively engaged (e.g., meshed or mated) with one another and disengaged from one another. The spring 34 is coupled to the second crown gear and the housing. The first crown teeth 16 are made of a non-magnetic material, including, without limitation, austenitic stainless steel, aluminum, brass, and/or other suitable materials or combinations of these materials providing physical characteristics such as strength and resilience to wear.

The second crown teeth 18 are made of a magnetic material, including, without limitation, ferromagnetic materials such as iron, nickel, 416 stainless steel, other suitable materials, and alloys thereof. In some embodiments, the magnetic material is a magnetically soft material, for example, a material having low or zero remanent magnetism and a high magnetic saturation value (e.g., iron and 80Ni-20Fe alloy), where the material is magnetized when an external magnetic field is applied and not magnetized (or only slightly magnetized) when the external magnetic field is not applied. In several embodiments, the low remanent magnetism is important as it can enable the gear engagement system to disengage more easily than otherwise. In one embodiment, the high magnetic saturation is important as it can enable the gear engagement system to engage at lower voltages.

The spring 34 provides a force along an axial direction (i.e., along the axis that the first and second crown gears rotate around) of the first and second crown gears to separate the first and second crown gears 12 and 14. The spring can have a spring constant such that the force applied by the spring when compressed is greater than any force generated by the magnetic field from remanent magnetism in the ring and the second crown teeth.

The ring 28 may be integrally formed as part of the housing 30. The ring 28 is composed of a magnetic material or composite thereof such that when the electromagnetic coil 32 generates a magnetic field, the ring 28 forms an electromagnet that draws the second crown gear 14 and the first crown gear 12 together. When the electromagnetic coil 32 is de-energized and is not generating a magnetic field, the magnetization of the ring 28 decreases (the amount by which the magnetization decreases depends on the magnetic hardness or softness of the material that the ring is composed of) to a level where a force applied by the spring 34 causes the first crown gear 12 and the second crown gear 14 to separate and to disengage from one another.

In the embodiment shown in FIG. 2, the ring 28 is located along an inner circumference of the first crown gear 12. However, in other embodiments, the ring may be located along an outer circumference of the first crown gear.

The first crown gear 12 and the ring 28 may be fixed together, for example, by welding or other suitable means. The first crown gear 12 and the ring 28 may also be fixed together by means of an interference fit in which one part slightly interferes with the space taken up by another part such that there is a high degree of friction between the two parts. For example, when the ring 28 is located at an inner circumference of the first crown gear 12, then an outer diameter of the ring 28 may be larger than an inner diameter of the first crown gear 12. This configuration stretches the first crown gear 12 and compresses the ring 28 such that there is a high amount of friction between the inner circumference of the first crown gear 12 and the outer circumference of the ring 28.

As another example, when the ring is located at an outer circumference of the first crown gear, then an outer diameter of the first crown gear may be larger than an inner diameter of the ring. This configuration stretches the ring and compresses the first crown gear when the two parts are placed together such that there is a high amount of friction between the inner circumference of the ring and the outer circumference of the first crown gear.

When the electromagnetic coil 32 of FIG. 2 is energized and generates a magnetic field of sufficient strength to overcome the force applied by the spring 34, the first crown gear 12 and the second crown gear 14 are drawn together such that they engage. When the first crown gear 12 and the second crown gear 14 are drawn together, the first crown teeth 16 may initially be out of alignment with the second crown teeth 18, such that tips of the first crown teeth 20 may be positioned at tips of the second crown teeth 22 (as opposed to roots of the second crown teeth 24, as would be desirable for a positive lock). However, as a relatively small amount of torque is applied to either the first crown gear or the second crown gear, positive lock engagement may be achieved.

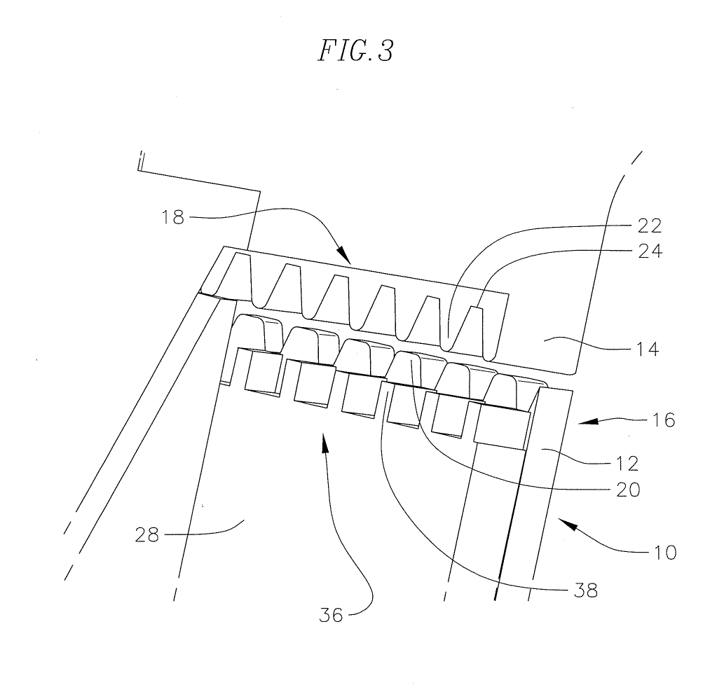

FIG. 3 is a perspective view of an inner portion of a first crown gear 12, a second crown gear 14, and a ring 28 of a gear engagement system according to one embodiment of the present invention.

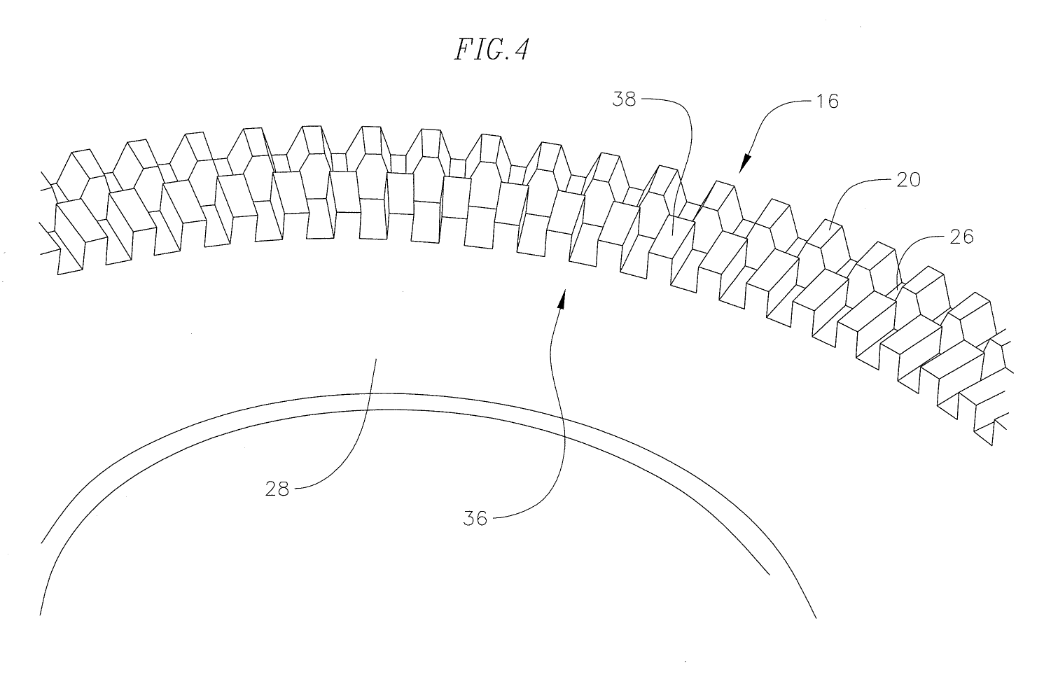

FIG. 4 is another perspective view of an inner portion of a first crown gear 12 and a ring 28 of a gear engagement system according to one embodiment of the present invention.

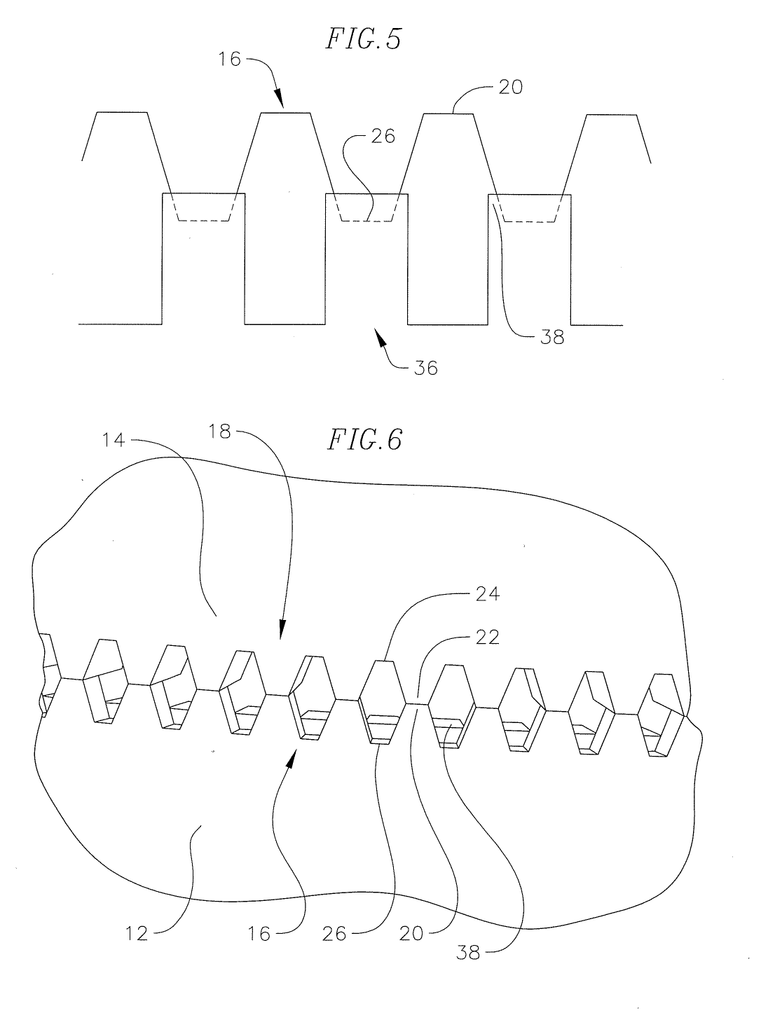

FIG. 5 is an enlarged side view of a portion of a first crown gear and a ring according to one embodiment of the present invention. FIGS. 3, 4, and 5 depict the first crown gear assembly 10 including a ring 28 with ring teeth 36. In the embodiments shown in FIGS. 3, 4, and 5, the ring teeth 36 are arranged such that the tips of the ring teeth 38 are about centered between adjacent tips of the first crown teeth 20 (i.e., such that the tips of the ring teeth 38 are about centered with the roots of the first crown teeth 26). However, in other embodiments, the tips of the ring teeth are not centered with the roots of the first crown teeth. In one such embodiment, for example, the tips of the ring teeth are slightly off-center (e.g., in reference to FIG. 5, the tips of the ring teeth may be shifted slightly to the left or to the right relative to the first crown teeth). In addition, in the embodiment illustrated in FIG. 5, the tips of the ring teeth 38 are positioned about one fourth of the distance between the tips of the first crown teeth 20 and the roots of the first crown teeth 26 above the roots 26. In other embodiments, the tips of the ring teeth 38 may be located at a different level. In one such embodiment, the tips are located at the same level as (or below) the roots 26 of the first crown teeth. In such case, the pull in voltage, or voltage required to bring the opposing crown teeth together, can be higher in this configuration. In several embodiments, the arrangement of the ring teeth with respect to the first crown teeth is dependent on the particular application for the gear engagement system.

In some embodiments, the first crown teeth and second crown teeth can have different shapes. In such case, changes in the angle of the sides of the teeth can offer different characteristics. For example, steeper teeth, generally speaking, can provide higher holding torque but also make it harder to disengage under load. On the other hand, less steep teeth can provide less holding torque while making it easier to disengage under load. In some embodiments, the tips of the engagement teeth can be pointed or rounded rather than flat.

In several embodiments, the shape of the magnetic teeth 36 of the ring 28 can also be varied. In one embodiment, for example, the magnetic ring teeth each have a wider base than the tip (e.g., similar to the first or second crown teeth). In such case, the flux level at the base of the teeth would be lower than at the tip, which could potentially lower the required engagement voltage. In some embodiments, the magnetic ring teeth can be pointed or rounded.

In the embodiments shown in FIGS. 3, 4, and 5, the magnetic field generated by the electromagnetic coil 32 magnetizes the ring 28. The tips of the second crown teeth 22 are then drawn toward the magnetized tips of the ring teeth 38 located at the roots of the first crown teeth 26. Therefore, the first and second crown teeth of the embodiments shown in FIGS. 3, 4, and 5 engage a positive lock engagement rather than a tip-to-tip engagement.

FIG. 6 is a side view of an outer portion of a gear engagement system where the tips of the first crown teeth 20 and the tips of the second crown teeth 22 are in contact with one another according to one embodiment of the present invention. However, as discussed above, in many embodiments of the present invention, this arrangement is likely to be temporary until minimal rotational torque and/or magnetic inertia overcome friction and a positive lock ensues.

In one embodiment, when the coil first becomes engaged, the system arrangement is relatively unstable and seeks the position where the reluctance will be the lowest. That position is magnetic tooth to magnetic root. In several embodiments, movement to the magnetic tooth to magnetic root position is obstructed by the non-magnetic teeth, and thus the unit will be stable magnetic tip (e.g., tip of second crown teeth) to magnetic tip (e.g., root of first crown teeth and tip of ring teeth). In such case, further motion would generally only occur if the system acted to reduce the reluctance. In several embodiments where the engagement is magnetic tip to non-magnetic tip as shown in FIG. 6, it is only because tips 20 of the first crown teeth 16 are in the way. In such case, it will not be stable until it attains a magnetic tip to magnetic tip position, which is the system's position of lowest attainable reluctance.

FIG. 7 is a side view of the outer portion of a gear engagement system where the first crown teeth 16 and the second crown teeth 18 are mated in a positive lock engagement according to one embodiment of the present invention.

In a number of embodiments, the gear engagement systems of FIGS. 3-7 can achieve positive lock in accordance with any of the methods discussed above.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A gear engagement system comprising:
a first crown gear assembly comprising:
a first crown gear comprising first crown teeth comprising a non-magnetic material; and
a ring comprising a first magnetic material and coupled along a circumference of the first crown gear;
a second crown gear comprising second crown teeth comprising a second magnetic material and configured to engage with the first crown teeth; and
switching circuitry for selectively engaging and disengaging the first crown teeth and the second crown teeth.

2. The system of claim 1, wherein the switching circuitry and the ring comprise an electromagnet.

3. The system of claim 2, wherein the switching circuitry is configured to engage the first crown gear with the second crown gear by inducing a magnetic field in the ring such that the second crown gear and the first crown gear are drawn together.

4. The apparatus of claim 1, wherein the first crown gear is welded to the ring.

5. The apparatus of claim 1, further comprising a housing, wherein the housing comprises the ring.

6. The apparatus of claim 1, wherein the first magnetic material and the second magnetic material are the same.

7. The apparatus of claim 1, wherein the ring is coupled along an inner circumference of the first crown gear.

8. The apparatus of claim 7, wherein a length of the inner circumference of the first crown gear is smaller than a length of an outer circumference of the ring.

9. The apparatus of claim 1, wherein the ring is coupled along an outer circumference of the first crown gear.

10. The apparatus of claim 9, wherein a length of the outer circumference of the first crown gear is longer than a length of an inner circumference of the ring.

11. The apparatus of claim 1, wherein the ring comprises a plurality of ring teeth, each of the ring teeth having a tip centered at a middle between two of the plurality of first crown teeth.

12. The apparatus of claim 11, wherein the ring teeth comprise the first magnetic material.

13. The apparatus of claim 11, wherein, in an engaged position, tips of the second crown teeth are magnetically coupled to the tips of the ring teeth.

14. The apparatus of claim 1, wherein, in an engaged position, tips of the first crown teeth are substantially mated with roots of the second crown teeth.

15. The apparatus of claim 1, wherein, in an engaged position, tips of the second crown teeth are substantially mated with roots of the first crown teeth.

16. The apparatus of claim 1, wherein, in an engaged position, the first crown gear and the second crown gear are configured to rotate in synchrony.

17. The apparatus of claim 1, wherein, in a disengaged position, the first crown gear and the second crown gear are configured to rotate independently.

18. A method of operating a gear engagement system comprising:
inducing a magnetic field in a ring comprising a magnetic material and located along a circumference of a first crown gear comprising a plurality of first crown teeth comprising a non-magnetic material,
wherein the first crown teeth are configured to engage with a plurality of second crown teeth of a second crown gear comprising a magnetic material, the second crown teeth being configured to engage with the first crown teeth,
wherein tips of the first crown teeth are configured to engage with roots of the second crown teeth and tips of the second crown teeth are configured to engage with roots of the first crown teeth, and
wherein the second crown teeth are configured to move toward the first crown teeth when the magnetic field is induced in the ring.

19. The method of claim 18, further comprising:
removing the magnetic field induced in the ring;
wherein a spring is configured to apply a restoring force to separate the first crown teeth from the second crown teeth when the magnetic field is not induced in the ring.
